(19) United States
(12) Patent Application Publication
(10) Pub. No.: US 2016/0211930 A1
(43) Pub. Date: Jul. 21, 2016

(54) RADIO AIRPLAY MONITOR DATA PASSIVE ALERT SYSTEM

(71) Applicant: Ralph G. CIPOLLA, Farmington Hills, MI (US)

(72) Inventor: Ralph G. Cipolla, Farmington Hills, MI (US)

(21) Appl. No.: 14/913,913

(22) PCT Filed: Aug. 25, 2014
(86) PCT No.: PCT/US2014/052523

§ 371 Date: Feb. 23, 2016

Related U.S. Application Data
(60) Provisional application No. 61/869,760, filed on Aug. 25, 2013.

(51) Int. Cl. H04H 20/14; H04H 60/29; H04H 60/58

(52) U.S. Cl. CPC H04H 20/14; H04H 60/58; H04H 60/29

(57) ABSTRACT

A method for monitoring entertainment media (such as songs played on the radio) may include providing a plurality of conditions related to frequency of performances of particular recordings of entertainment media, receiving a selection of a subset of the conditions from a user, monitoring data of frequency of performances of the particular recordings of entertainment media, and transmitting an alert to the user when one or more conditions in the subset of conditions is met based on the data.

### CROSS-REFERENCE TO RELATED APPLICATION

This application claims the benefit of U.S. provisional application No. 61/869,760, filed Aug. 25, 2013, now pending, which is hereby incorporated by reference in its entirety.

### BACKGROUND

a. Technical Field

The instant disclosure relates to monitoring and analyzing airplay of entertainment media, including transmission of alerts upon certain conditions being met in the airplay of entertainment media.

b. Background Art

Services exist that allow subscribers to access music radio station airplay data at-will (i.e. song, artist, title, year released, day/time aired, etc.). This data, which may be updated hourly, daily, etc., is of value to radio station operators who wish to: (i) ensure their station execution is consistent with chosen competitive strategy, (ii) possess up-to-date data regarding competitors, (iii) and review airplay trends at other stations. Presently, subscribers must actively log-in to such a site, and then perform analysis across a wide variety of data points to learn if their station is in strategic compliance and/or if a competitor has made adjustments that merit concern.

Radio airplay data services are often under- or poorly-utilized by subscribers; data is accessed and reviewed infrequently, inconsistently, incompletely, and/or in a time of product or competitive crisis. Subscribers may be too busy or lack the presence of mind to schedule a regular and thorough review of data for their own and other stations. Quite often, they do so only when a perceived product miscue or competitive shift is brought to their attention in subjective, anecdotal form. In this case, the outcome is often: (i) an inaccurate anecdote that results in wasted hours in an attempt to track down a perceived issue that does not exist, or (ii) discovery of a genuine issue/competitive threat. The former represents lack of efficiency; the latter represents a lost opportunity to discover and address real issues at a much earlier stage. Moreover, many subscribers lack the skill and experience required to: (a) identify specific data reports that are relevant to the situation of concern, and, (b) once data is downloaded, transform or convert raw data into meaningful, actionable information.

The foregoing discussion is intended only to illustrate the present field and should not be taken as a disavowal of claim scope.

### BRIEF SUMMARY

A system for monitoring entertainment media, such as but not limited to songs played on terrestrial radio, may include a processor and a memory in communication with the processor. The memory may include instructions that, when executed by the processor, cause the processor to perform a method. The method may include providing a plurality of conditions related to frequency of performances of particular recordings of entertainment media, receiving a selection of a subset of the conditions from a user, monitoring data of frequency of performances of the particular recordings of entertainment media, and transmitting an alert to the user when one or more conditions in the subset of conditions is met based on the data.

A method for monitoring entertainment media may include providing a plurality of conditions related to frequency of performances of particular recordings of entertainment media, receiving a selection of a subset of the conditions from a user, monitoring data of frequency of performances of the particular recordings of entertainment media, transmitting an alert to the user when one or more conditions in the subset of conditions is met based on the data.

### BRIEF DESCRIPTION OF THE DRAWINGS

FIG. 1 is a block diagram view of a system for monitoring entertainment media airplay data and providing alerts for conditions related to that data.

FIG. 2 is a flow chart illustrating a method of monitoring entertainment media airplay data and providing alerts for conditions related to that data.

FIG. 3 is an exemplary graphical user interface for selecting conditions related to frequency of performances of entertainment media.

### DETAILED DESCRIPTION

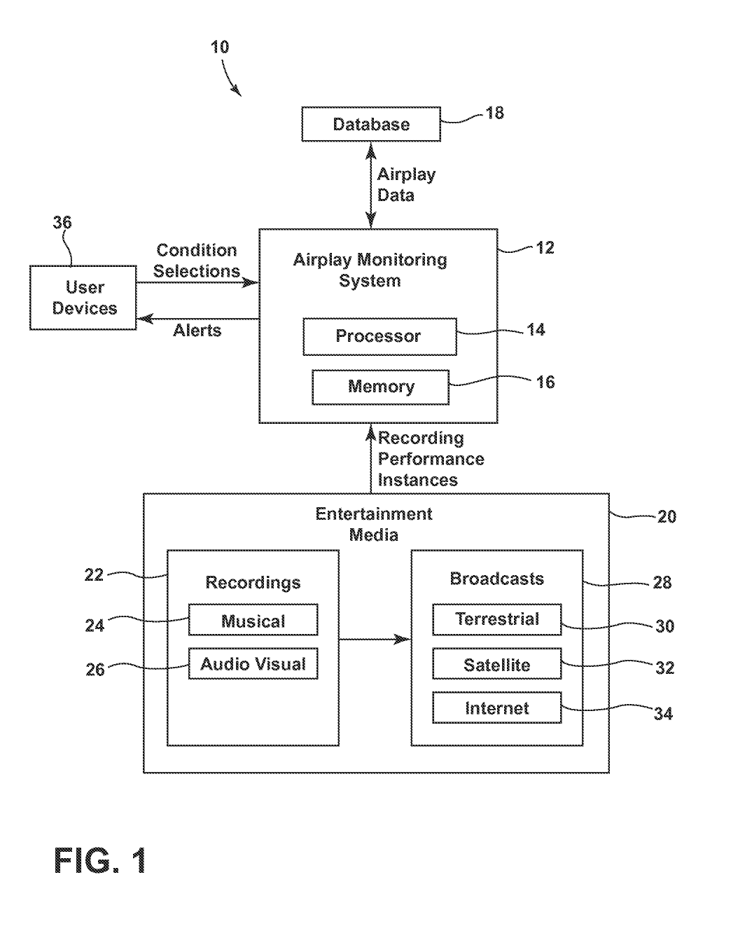

Referring now to the figures, in which like numerals indicate the same or similar elements in the various views, FIG. 1 is a block diagram view of a system 10 for monitoring entertainment media airplay data and providing alerts for conditions related to that data. The system 10 may include an airplay monitoring system 12, which may include a processor 14 and a memory 16, and a database 18.

The memory 16 may be or may include any type of volatile or non-volatile computer-readable memory. For example, the memory 16 may comprise a hard disk drive (HDD), random-access memory (RAM), read-only memory (ROM), electrically-erasable programmable read-only memory (EEPROM), FLASH memory, compact disk (CD), digital video disk (DVD), and/or another type of electronic storage medium. The memory 16 may include a remote (e.g., cloud-based) storage medium, in an embodiment, that is in electronic communication with the airplay monitoring system 12. The processor 14 may include any type of computer processor. The memory 16 may be configured to store instructions that embody one or more steps, methods, processes, and functions of the airplay monitoring system 12 described herein. The processor 14 may be configured to execute those instructions to perform one or more of the same steps, methods, processes, and functions.

The airplay monitoring system 12 may be in electronic communication with, or may include, the database 18. The database 18 may be or may include one or more data repositories including, but not limited to, one or more databases and database types as well as electronic data storage that may not necessarily be colloquially referred to as a “database.” For example, in an embodiment, the database 18 may be a relational database.

The airplay monitoring system 12 may be configured to monitor airplay of entertainment media 20. Entertainment media 20 may include recordings 22 of musical works 24, such as songs, and audiovisual works 26, such as movies and television or other serial programs, that are broadcast 28 over terrestrial channels 30 (e.g., terrestrial radio stations or terrestrial television stations, including both cable-based and “over-the-air” broadcasts), satellite channels 32 (e.g., satellite radio or satellite television), and/or internet channels 34 (e.g., streaming), in an embodiment. The airplay monitoring system 12 may be configured to monitor airplay of any subset of entertainment media recordings 22 and any subset of entertainment media broadcast channels 28, in embodiments.

The remainder of this disclosure will be with respect to an embodiment in which the airplay monitoring system 12 is configured to monitor airplay of musical works 24 over terrestrial channels 30 (i.e., terrestrial radio, which may be referred to herein simply as “radio”) and the database 18 is configured to store data respective of radio airplay (e.g., data respective of songs played over terrestrial radio). It should be understood, however, that this is for ease of description only, and the airplay monitoring system 12 and database 18 are not restricted to a particular recording type 22 or broadcast channel type 28 except as explicitly set forth in the claims.

The airplay monitoring system 12 may be in electronic communication with one or more users (e.g., a plurality of users) via one or more user devices 36 (e.g., a plurality of user devices). A user device 36 may be a personal computer or mobile device (e.g., mobile phone or tablet) associated with a user, in an embodiment. The airplay monitoring system 12 may be in communication with the one or more user devices 36 over the Internet, in an embodiment.

The airplay monitoring system 12 may be a part of and/or may be in communication with a traditional airplay monitoring service (i.e., a system thereof) such as, for example, the MEDIABASE service provided by Premiere Radio Networks, Inc. of Sherman Oaks, Calif., the BDSradio service provided by the Nielsen Company of New York, N.Y., the Radio Monitor service provided by Radiomonitor Limited of London, England, United Kingdom, or the RadioWave Monitor service provided by Concentus Music Group CMG.

In an embodiment, the airplay monitoring system 12 may be configured to monitor radio airplay—i.e., receive radio broadcasts, count or otherwise track instances of performances of particular songs over those broadcasts, store data regarding those instances (e.g., store data respective of when and on what channel those particular songs are played in the database, as well as data respective of the songs themselves), and transmit alerts regarding the data and/or the instances of broadcast to the one or more user devices 36. For example, the airplay monitoring system 12 may monitor a plurality of radio stations and transmit alerts to the one or more user devices 36 when airplay meets certain thresholds, which may be selected by a user, in an embodiment.

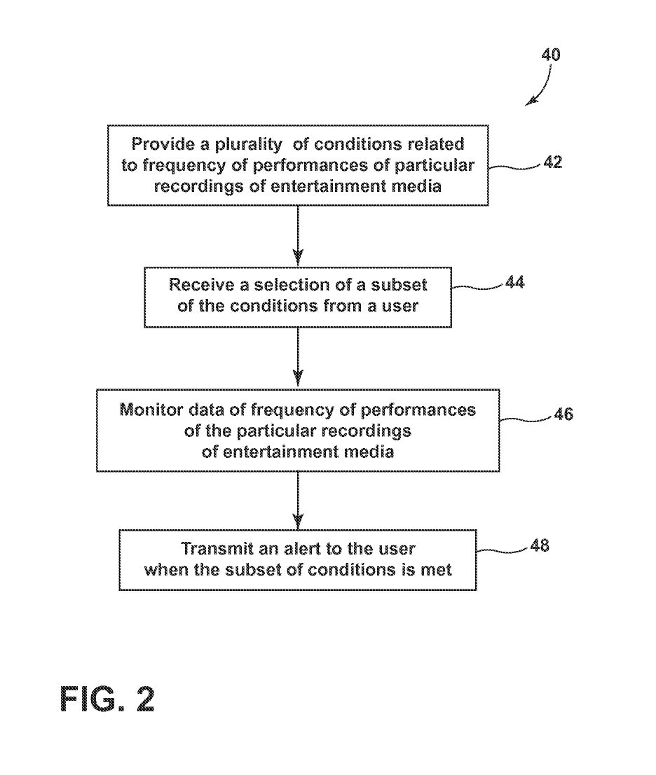

FIG. 2 is a flow chart illustrating a method 40 of monitoring entertainment media airplay data and providing alerts for conditions related to that data. Referring to FIGS. 1 and 2, one or more steps of the method 40 may be executed by the airplay monitoring system 12. That is, one or more steps of the method 40 may be embodied in instructions stored in the memory 16 and may, when executed by the processor 14, cause the airplay monitoring system 12 to perform the one or more steps of the method 40.

The method 40 may begin with a step 42 that includes providing a plurality of conditions related to frequency of performances of particular recordings of entertainment media. The recordings of entertainment media may be, in an embodiment, musical recordings 24, such as songs. The performances may be, in an embodiment, broadcasts 28 of the musical recordings on radio stations.

With continued reference to FIGS. 1 and 2, the plurality of conditions may be provided by the airplay monitoring system 12 to the user device 36 (e.g., to each of a plurality of user devices) through a graphical user interface. For example, the airplay monitoring system 12 may provide a graphical user interface on a website that may be accessed by one or more user devices 36, in an embodiment.

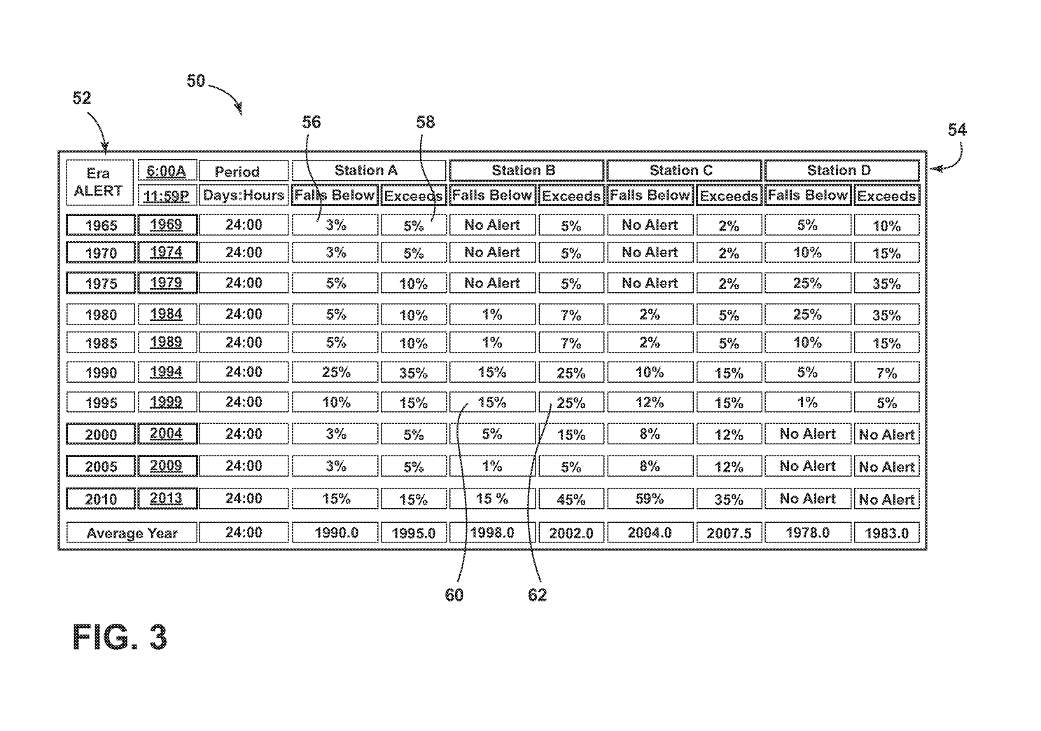

FIG. 3 illustrates a portion of an exemplary graphical user interface 50 that may be provided, through which a plurality of conditions may be provided. The conditions may be related, in an embodiment, to a frequency of performances of particular songs. For example, the conditions may be related to frequency of performances of particular songs on particular radio stations. In an embodiment, the conditions may be related to songs from a particular time period in which the song was recorded. In an embodiment, the conditions may be related to a particular time of day at which the song was played. In an embodiment, the conditions may be related to a particular day of the week on which the song was played. In an embodiment, the conditions may be related to a genre of song. In an embodiment, the conditions may be related to a specific artist or album. In an embodiment, the conditions may be related to a total number of songs played within a particular period of time. Of course, additional or alternative conditions may be provided, particularly in an embodiment in which the conditions are related to entertainment media other than songs.

In the embodiment illustrated in FIG. 3, the interface 50 provides a plurality of conditions related to songs recorded in particular time periods played on particular terrestrial radio stations at a particular time of day. In the illustrated interface, rows 52 are assigned to ten (10) time periods and columns 54 are assigned to four (4) radio stations. Of course, as noted above, additional or alternative conditions may be provided for selection by the user.

If a threshold is exceeded (i.e., in the embodiment of FIG. 3, if airplay of songs for a particular radio station of songs recorded in a particular time period falls below an indicated lower threshold or goes above an indicated upper threshold), an alert may be transmitted to the user who set the threshold.

Referring again to FIG. 2, the providing step 42 may involve providing conditions in a manner other than through a graphical user interface, in an embodiment. For example, the conditions may be provided through text messages, in an embodiment.

The method 40 may continue to a step 44 that includes receiving a selection of a subset of the provided conditions from a user. For example, referring again to FIG. 3, a user's selection of a subset of conditions may be received through the graphical user interface 50. In an embodiment, a user may select a subset of conditions by indicating thresholds for certain conditions. In the exemplary embodiment of FIG. 3, a user has selected each condition with which a percentage is associated. On the other hand, the user has not selected each condition for which “No Alert” is indicated (i.e., such as the interface portion for a lower threshold for airtime on Station 4 of songs recorded between 2005 and 2009).

In an embodiment, a user may select a subset of conditions by assigning thresholds for one or more conditions, or combinations of conditions. For example, as illustrated in FIG. 3, a user may set a threshold for songs from particular time periods played on particular radio stations. In the exemplary interface of FIG. 3, thresholds are assigned to upper and lower bounds of percentages of airplay time of particular radio stations dedicated to songs recorded in particular time periods. For example, in a first set of thresholds, a lower threshold 56 is indicated as 3%, and a upper threshold 58 is indicated as 5%, for airplay time of Station A of songs recorded between 1965 and 1969; in a second set of thresholds, a lower threshold 60 is indicated as 15%, and an upper threshold 62 is indicated as 25%, for airplay time of Station B of songs recorded between 1995 and 1999. Similar threshold sets may be set, in an embodiment, for songs recorded in any given time period for any radio station, or for any condition provided (which, as noted above, is not limited to time periods of recordings or to particular stations).

In the illustrated embodiment, conditions are selected by a user by assigning a percentage threshold to those conditions, as noted above. In an embodiment, conditions may also be selected by assigning some other value to the condition (i.e., other than a percentage), such as a binary value, raw integer value, or other value.

Referring again to FIG. 2, the method 40 may continue to a step 46 that includes monitoring data of frequency of performances of the particular recordings of entertainment media associated with one or more of the conditions selected by the user. The monitoring step 46 may include, in an embodiment, a substep that includes periodically comparing one or more conditions (e.g., thresholds or other values associated with one or more conditions) selected by the user with data respective of those conditions.

Referring again to FIG. 1, the values associated with the conditions selected by the user (e.g., the thresholds or other values associated with those conditions) may be stored in the airplay monitoring system 12. Additionally or alternatively, the values associated with the conditions selected by the user, and/or the conditions themselves, may be stored in the database 18. The airplay monitoring system 12 may be configured to compare the one or more conditions selected by the user (e.g., the values associated with those conditions) with data stored in the database 18. For example, referring to FIGS. 1 and 3, the database 18 may have data respective of airplay time dedicated to songs recorded in particular time periods by particular radio stations, and the airplay monitoring system 12 may be configured to compare the thresholds indicated by the user to that data. The airplay monitoring system 12 may be configured to automatically (i.e., without requiring user interaction) make comparisons on a periodic basis (i.e., hourly, daily, etc.).

The frequency of comparisons may be selected by the user, in an embodiment. Additionally or alternatively, the frequency of comparisons may depend on the conditions selected by the user. For example, a user may select conditions related to a number of times a song, artist, genre, etc. is played within a certain time period (e.g., within a certain number of minutes, within an hour, within any period of a certain number of consecutive hours, within a specified set of consecutive hours (e.g., 4-6 p.m.) or other specified collection of hours, within a calendar day, within a specified number of calendar days, within a specified set of days of the week, etc. The airplay monitoring system 12 may make comparisons with the same or more frequent temporal resolution as the selected conditions (i.e., if a selected condition is “if Song X is played more than twice on Station D in any two-hour period,” then the airplay monitoring system may be configured to compare the condition to the data at least every two hours), in an embodiment.

Returning to FIG. 2, the method 40 may further include a step 48 that includes transmitting an alert to a user when a condition selected by the user has been met. The alert may be transmitted automatically, in an embodiment. For example, an alert may be transmitted to the user when an indicated threshold is exceeded or some other value associated with a condition has been exceeded, met, etc. Referring to FIG. 3, an alert may be transmitted to the user of the illustrated graphical user interface 50 when the airplay time on Station A of songs recorded between 1965 and 1969 falls below the indicated lower threshold 56 of 3% or rises above the indicated upper threshold 58 of 5%. Similarly, alerts may be transmitted for any other thresholds that have been exceeded (i.e., airplay below a lower threshold or above an upper threshold) or other values that have been met or exceeded.

An alert may be sent as soon as it is determined that a threshold has been exceeded, in an embodiment. Additionally or alternatively, one or more alerts may be sent at scheduled times and on scheduled days. When and how often alerts are sent may be selected by the user, in an embodiment. Such selection may be made through the same graphical user interface 50 through which the plurality of conditions is provided and through which the subset of conditions is selected, in an embodiment.

Referring to FIG. 1, alerts may be sent by the airplay monitoring system 12 to a user device 36 associated with the user that selected the condition that has been met to trigger the alert. The alert may be in one or more of many forms. For example, the airplay monitoring system 12 may be configured to send a text message to a user's mobile phone, to send an email to a user, to automatically call the user's mobile phone or other phone, to send a message to a user's account associated with the airplay monitoring system, to send a message to a user's account on a social media platform, and/or through some other notification means.

A subset of conditions may be selected by a user such that an alert is transmitted upon a particular combination of conditions being met, in an embodiment. For example, a user may select a subset of five conditions and select that an alert be sent if three of the five conditions are met, or two of the five conditions are met, or four of the five conditions are met. Furthermore, in an embodiment, a subset of conditions may be selected by a user such that an alert is transmitted upon a particular sequence of the conditions in the subset being met (i.e., in an order selected by the user). Furthermore, in an embodiment, a user may select a subset of conditions such that one condition in the subset being met negates an alert being transmitted for another condition in the subset being met, where the other condition being met would otherwise trigger an alert.

Referring to FIG. 1, the airplay monitoring system 12 may be configured to transmit an alert containing information useful to the user and related to the condition or conditions which were met so as to trigger the transmission of the alert. For example, in an embodiment, an alert may include the selected condition or conditions, a value associated with that condition or conditions (e.g., a percentage of airplay on a particular station where the condition was an upper or lower threshold associated with that percentage), a link to a more lengthy report, and/or other information. In an embodiment, the amount and types of information contained in an alert may be selected by a user, such that each alert transmitted by the airplay monitoring system is customized for the user to whom it is transmitted.

The alert, or a report to which the alert may link, may include one or more of a variety of types of information presented in one or more of a variety of formats. For example, the alert or report may include airplay statistics of a song, artist, genre, station of interest, etc. to which the met condition is related. The report may include information in a chart, table, graphic-based visualization of relevant data, text-based summary of relevant data, etc. Furthermore, in an embodiment, the alert or report may include a link, reference, or other prompt to the underlying data (i.e., the airplay data stored in the database 18), which the user may follow to review the underlying data in greater detail, if desired.

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment”, or the like, means that a particular feature, structure, or characteristic described in connection with the embodiment is included in at least one embodiment. Thus, appearances of the phrases “in various embodiments,” “in some embodiments,” “in one embodiment,” or “in an embodiment”, or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional.

Although numerous embodiments of this invention have been described above with a certain degree of particularity, those skilled in the art could make numerous alterations to the disclosed embodiments without departing from the spirit or scope of this disclosure. All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the any aspect of the disclosure. As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A system comprising:
a processor; and
a memory, in communication with the processor, including instructions that, when executed by the processor, cause the processor to perform a method comprising:
providing a plurality of conditions related to frequency of performances of particular recordings of entertainment media;
receiving a selection of a subset of the conditions from a user;
monitoring data of frequency of performances of the particular recordings of entertainment media; and
transmitting an alert to the user when one or more conditions in the subset of conditions is met based on the data.

2. The system of claim 1, wherein the particular recordings of entertainment media comprise musical works.

3. The system of claim 1, wherein the performances of particular recordings comprise transmission of the recordings over terrestrial radio.

4. The system of claim 1, wherein the performances of particular recordings comprise transmission of the recordings over satellite radio.

5. The system of claim 1, wherein the performances of particular recordings comprise streaming the recordings over the Internet.

6. The system of claim 1, wherein the alert comprises an email.

7. The system of claim 1, wherein the alert comprises a text message.

8. The system of claim 1, wherein the plurality of conditions related to frequency of performances of particular recordings of entertainment media are provided to the user through a graphical user interface.

9. The system of claim 1, wherein monitoring data of frequency of performances of the particular recordings of entertainment media comprises comparing the subset of conditions to the data at least once per day.

10. The system of claim 1, further comprising a database, in electronic communication with the processor, that stores the data of frequency of performances of the particular recordings of entertainment media.

11. A method comprising:
providing a plurality of conditions related to frequency of performances of particular recordings of entertainment media;
receiving a selection of a subset of the conditions from a user;
monitoring data of frequency of performances of the particular recordings of entertainment media; and
transmitting an alert to the user when one or more of the subset of the conditions is met based on the data.

12. The system of claim 11, wherein the particular recordings of entertainment media comprise musical works.

13. The system of claim 11, wherein the performances of particular recordings comprise transmission of the recordings over terrestrial radio.

14. The system of claim 11, wherein the performances of particular recordings comprise transmission of the recordings over satellite radio.

15. The system of claim 11, wherein the performances of particular recordings comprise streaming the recordings over the Internet.

16. The system of claim 11, wherein the alert comprises an email.

17. The system of claim 11, wherein the alert comprises a text message.

18. The system of claim 11, wherein the plurality of conditions related to frequency of performances of particular recordings of entertainment media are provided to the user through a graphical user interface.

19. The system of claim 11, wherein monitoring data of frequency of performances of the particular recordings of entertainment media comprises comparing the subset of conditions to the data at least once per day.

20. The system of claim 11, wherein the data of frequency of performances of the particular recordings of entertainment media is stored in a database.
